(19) United States
(12) Patent Application Publication
(10) Pub. No.: US 2010/0012395 A1
(43) Pub. Date: Jan. 21, 2010

(54) Scale

(75) Inventors: Jevgenij Mannhart, Cham (CH); Cyrill Röthlin, Hunenberg (CH); Marc Robert, Kussnacht (CH); Jérôme Bernhard, Zurich (CH)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: CARAG AG, Baar (CH)

(21) Appl. No.: 12/447,041

(22) PCT Filed: Oct. 23, 2007
(86) PCT No.: PCT/CH07/00526

§ 371 Date: Apr. 24, 2009

(30) Foreign Application Priority Data
Oct. 24, 2006 (CH) 1685/06

(51) Int. Cl. G01G 19/44

(52) U.S. Cl. 177/210 EM

(57) ABSTRACT

The invention relates to scales comprising a bearing surface for supporting a load to be weighed, an electroconductive sensor plate, a flat coil arranged at a distance from the sensor plate and used for the inductive measurement of a distance between the sensor plate and the flat coil, a housing surrounding the sensor plate and the flat coil, and a push-button which protrudes out of the housing and is connected to the sensor plate. The inventive scales are easy to assemble but also versatile.

### TECHNICAL FIELD

The invention relates to a balance or a scale having a supporting surface for supporting a weight to be weighed. The scale apparatus is suitable, in particular, for determining small weights in the range of a few grams up to several hundred kilograms, or for determining weighted differences in the range of up to 0.1% of the maximum weight.

### PRIOR ART

Very greatly differing scales are known from the prior art. Just as different are the measurement techniques used.

U.S. Pat. No. 4,503,922 exhibits a bathroom scale with a flat measuring coil and a torsion bar.

EP 0, 299,395 exhibits a capacitive weight measurement with electrodes. A pushbutton projects from a housing of the electrodes. A transfer pin projects from a housing arranged above it.

Furthermore, there is known from EP 1 357 370 an inductive force sensor in the case of which the force to be determined is applied to a metal diaphragm. A flat coil is used for inductive measurement of the spacing between the diaphragm and the flat coil. A circuit suitable for operating this flat coil is known, for example, from EP 913 857. Similar arrangements are known for a differential pressure sensor from EP 0 774 651, and for a temperature sensor from EP 0 696 727.

### SUMMARY OF THE INVENTION

It is an object of the invention to provide a balance or a scale apparatus that is simple in design, is inexpensive and which can be applied in a versatile fashion.

This object is achieved by a scale apparatus or scale device having the features of patent claim 1.

The inventive scale apparatus has a supporting surface for supporting a weight to be weighed, an electrically conducting sensor plate, a flat coil, arranged at a spacing from the sensor plate, for the inductive measurement of a spacing between the sensor plate and the flat coil, a housing surrounding the sensor plate and the flat coil, and a pushbutton that projects from the housing and is connected to the sensor plate.

The sensor proven in other applications as a temperature, force and differential pressure sensor (see above-named publication) can be converted to a scale apparatus by simple means. The supporting surface for the scale apparatus can be connected to the pushbutton in one design.

The pushbutton preferably projects downward beyond the housing on an underside of the housing, the supporting surface being arranged on the opposite side of the housing. The connection between the pushbutton and diaphragm is thereby more effectively protected, and the scale apparatus is less susceptible to interference. In this case, the underside of the housing preferably forms a lower stop surface of the scale apparatus. This also reduces the interference susceptibility, since the scale apparatus cannot be overloaded. The length of the pushbutton, or the spacing between the stop surface and the bottom in the unloaded state can be selected such that the diaphragm can be deformed exclusively in its elastic region, and therefore can always return again to its originally unloaded shape.

It is also possible to use other types of stops in order to prevent overloading. Thus, for example, a distance holder can be arranged between the coil and sensor plate. Moreover, it is also possible for there to rise above a base plate a pin on which a part, for example the housing, stands in the event of a large load on the scale apparatus.

The housing is preferably made at least partly from metal such that it forms an electrical shield for its interior.

The scale apparatus can comprise the above-named elements in a fashion integrated in the housing, the only additional requirement being to integrate the corresponding electric circuit for operating the flat coil. However, it is also possible for a plurality of individual housings, each including for themselves alone a weighing element independent of the others, to be connected to a larger scale apparatus over a common supporting surface. It is advantageous in this case for the individual weighing elements to be independent sensors that need not be interconnected electronically.

The inventive scale apparatus can be used in a versatile fashion, for example as a personal scale apparatus, as a package scale apparatus, as a kitchen scales, in production lines and in production facilities. In particular, they can be used as a baby scales and/or for measurement of a pumped or just pumped amount of mother's milk.

Further advantageous embodiments emerge from the dependent patent claims.

### BRIEF DESCRIPTION OF THE DRAWINGS

The subject matter of the invention is explained below with the aid of preferred exemplary embodiments that are illustrated in the attached drawings, in which:

FIG. 1 shows a side view of a scale apparatus in accordance with the invention;

FIG. 2 shows a longitudinal section through the scale apparatus in accordance with FIG. 1;

FIG. 3 shows an exploded illustration of the scale apparatus in accordance with FIG. 1;

FIG. 4 shows a schematic illustration of an inventive scale apparatus with a plurality of housings;

FIG. 5 shows a side view of an inventive scale apparatus in a further embodiment;

FIG. 6a shows a longitudinal section through the scale apparatus in accordance with FIG. 5;

FIG. 6b shows a longitudinal section through a variant of the scale apparatus in accordance with FIG. 5; and

FIG. 7 shows an exploded illustration of the scale apparatus in accordance with FIG. 6b.

### WAYS OF IMPLEMENTING THE INVENTION

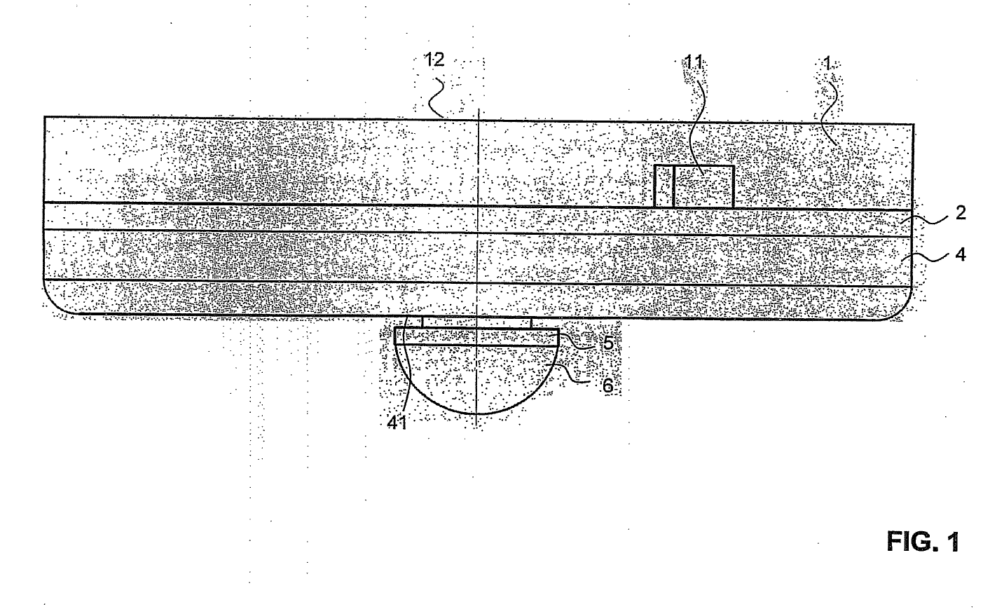

FIG. 1 illustrates an inventive scale apparatus. They have a housing with an upper housing part 1 and a lower housing part 4. Between the two housing parts 1, 4 is a printed circuit board 2. It can be arranged completely inside the housing 1, 4 or, as illustrated here, be designed to be so large that it forms part of the outer shell of the housing. The printed circuit board 2 is preferably round, and the housing 1, 4 a flat circular cylinder. In this example, the housing is made at least partly, preferably entirely from metal.

A cable opening 11 is present in the shell of the upper housing part 1 in order to guide the electric lines from the current source to the printed circuit board 2 and in order to transmit the sensor signal to a display unit and, if appropriate, to an evaluation unit where it is changed into an indication of weight. It is also possible to arrange a current source inside the housing and to fit a display unit on the housing.

The upper flat surface of the upper housing part 1 forms a supporting surface 12 for a weight to be weighed. The lower surface of the lower housing part 4 forms a stop surface 41. In the unloaded state of the scale apparatus, this stop surface 41 does not lie on the bottom, but is arranged above a pushbutton 6 at a spacing therefrom. The pushbutton 6 is located in a sleeve 5 and projects downward therefrom on the lower side of the housing 1, 4. It is held displaceably relative to the lower housing part 4. It preferably lies in punctiform fashion on the bottom, for example having a spherical head or one in the shape of a partial sphere.

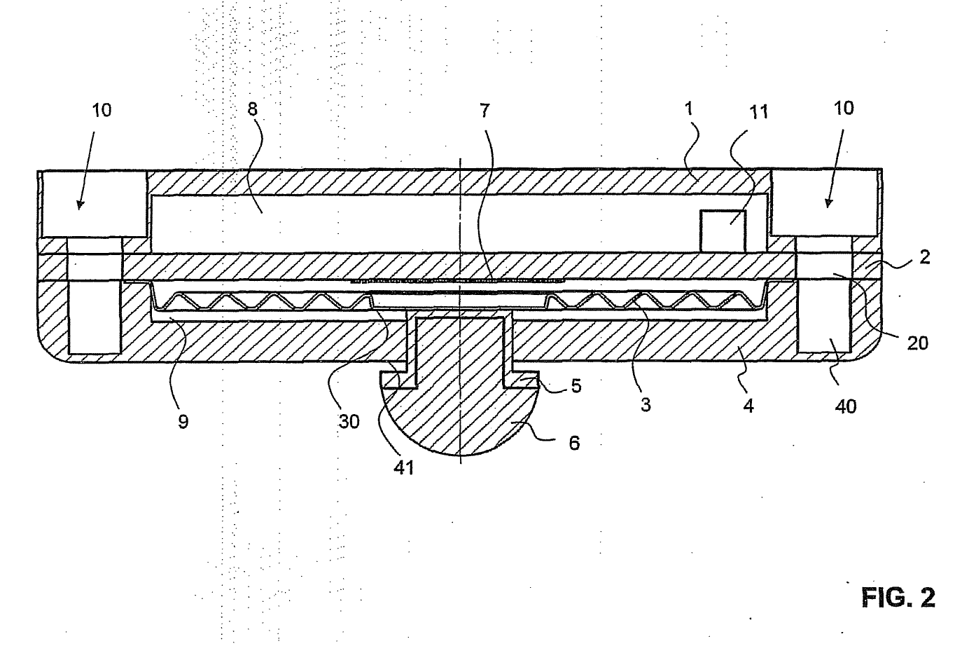

The interior of the scale apparatus in accordance with FIG. 1 is to be seen in FIG. 2. The housing parts 1, 4 and the printed circuit board 2 have feed-through openings 10, 20 or a blind hole 40 which are aligned with one another. It is thereby possible to screw the housing together. Other types of connection are also possible, however, for example clamping.

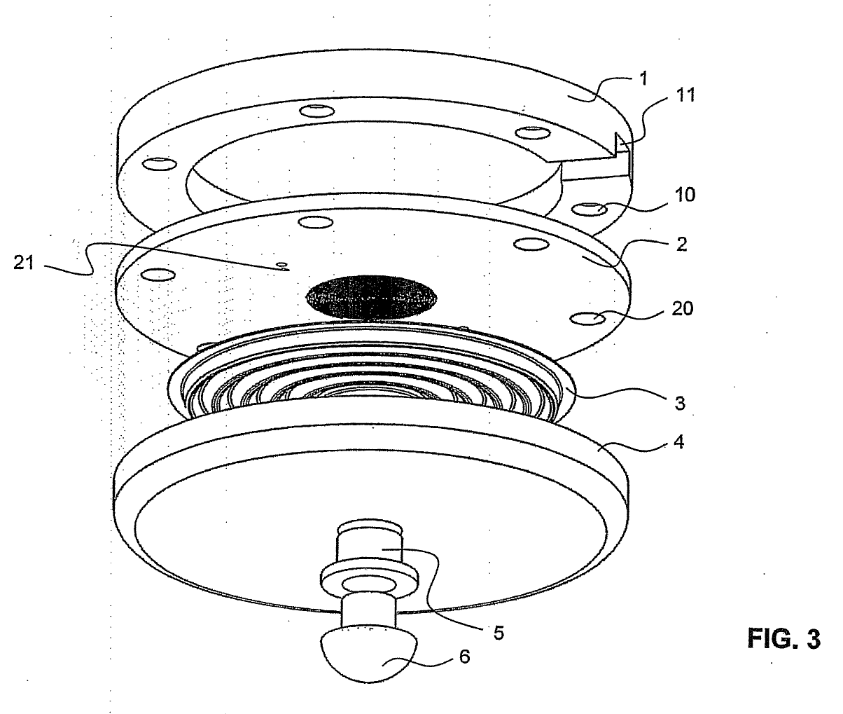

As is to be seen in FIG. 2, two cavities 8, 9 are present in the interior of the housing and are separated from one another by the printed circuit board 2. A flat coil 7 and an electric circuit (not illustrated) for operating the flat coil are arranged on the printed circuit board 2. The flat coil 7 is preferably integrated in the printed circuit board, in particular as a strip conductor which runs in a spiral fashion. The flat coil 7 is arranged on the lower side of the printed circuit board 2. Adjacent thereto and covering its surface area, a sensor plate 3 is arranged in the lower cavity 9. In the example illustrated here, the sensor plate is a diaphragm 3 that is held fixed in place between the printed circuit board 2 and the lower housing part 4, as is to be seen in FIG. 3. The diaphragm 3 is located at a defined spacing from the coil 7.

The diaphragm 3 is preferably of round design. It is made from a metal, in particular from copper beryllium, stainless steel, beryllium bronze or nickel silver. It usually has a thickness of 40 to 500 μm. However, it can also be rectangular or oval, or have another shape. Its thickness can also lie outside the value range specified above. In this case, however, the shapes of the housing and of the printed circuit board are preferably adapted correspondingly.

The diaphragm 3 has concentric corrugations, or the diaphragm is appropriately bent. A middle round area of the diaphragm 3 is preferably designed to be free from corrugation and flat. It forms a pressure surface 30. The sleeve 5 and thus the pushbutton 6 are arranged on this pressure surface 30 or operationally connected thereto. If a weight is now laid onto the supporting surface 12, the housing 1, 4 is pressed downward. The pressure surface 30 presses onto the pushbutton 6 which, however, does not yield but along which the upper housing part 4 slides downward. The pressure surface 30 is thereby brought closer to the coil 7, and the spacing is reduced. The stop surface 41 prevents the diaphragm from being able to be pressed together to a desired extent, and/or prevents it from touching the flat coil 7. The length of the projecting part of the pushbutton 6, that is to say the part that projects in the unloaded state beyond the lower stop surface 41, is preferably dimensioned such that the diaphragm 3 moves exclusively in the elastic or linear region.

The pushbutton 6 thus transfers the weight to be weighed onto the diaphragm 3, the spacing of the latter from the flat coil 7 thereby being changed such that the inductance of the coil 7 or its impedance changes. These changes can be measured as change in the resonant frequency and/or the attenuation when the coil 7 is arranged electrically in a series or parallel resonant circuit.

During operation, a radio frequency alternating current is applied to the coil 7, which thereby generates a radio frequency magnetic field. The frequency f of the alternating current is selected to be so high that the penetration depth of the magnetic field into the diaphragm 3 is much smaller than the thickness thereof. The penetration depth δ is determined by the skin effect. The frequency is typically a few MHz. The output signal of the flat coil 7, which varies as a consequence of the change in the spacing between the diaphragm 3 and the coil 7, is, for example, the resonant frequency of the resonant circuit formed from the flat coil 7 and a capacitor, or the amplitude of the AC voltage present at the flat coil 7, or the phase angle between the AC voltage present at the flat coil 7 and the oscillator, or another signal directly derived from the flat coil 7. It is preferred to operate with current resonance, the working point lying in the edge in the linear region of the characteristic. The flat coil 7 therefore serves, on the one hand, to generate an alternating magnetic field, and to detect the effect exerted on the magnetic field of the coil in push-pull fashion by the electromagnetic field of the diaphragm generated by the skin effect.

Instead of using the diaphragm 3, it is also possible to use a torsion bar that is clamped at one or both ends and to which the pushbutton 6 is applied. The torsion bar is likewise made from an electrically conducting material, preferably from metal. However, the diaphragm has the advantage that no measureable hysteresis occurs.

The scale apparatus preferably has at least one opening 21 such that ambient air bears on both sides of the diaphragm. There is a plurality of openings here. However, it is also possible for the housing to have an airtight seal so that a constant pressure prevails in the interior.

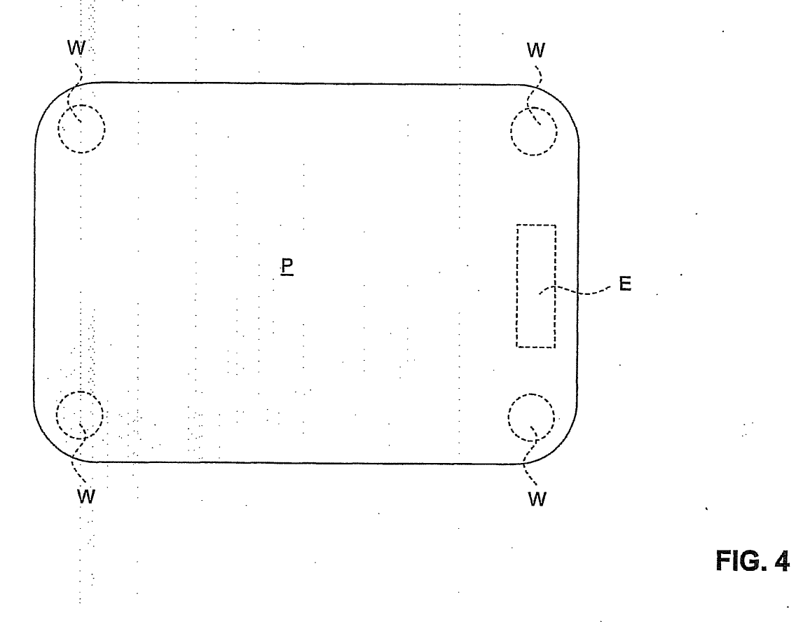

FIG. 4 illustrates a scale apparatus that is assembled from a plurality of weighing elements W as the latter are described above. Four weighing elements W are present here, being interconnected via a common support plate P. The weighing elements W are independent of one another and respectively supply their measurement results directly to evaluation electronics E. Here, as well, the pushbuttons 6 are preferably arranged projecting downward, but they can also be directed upward toward the common support plate P. The support plate P forms a stop against the supporting surfaces 12 that prevents the diaphragm 3 from being excessively stressed in the nonlinear or nonelastic region.

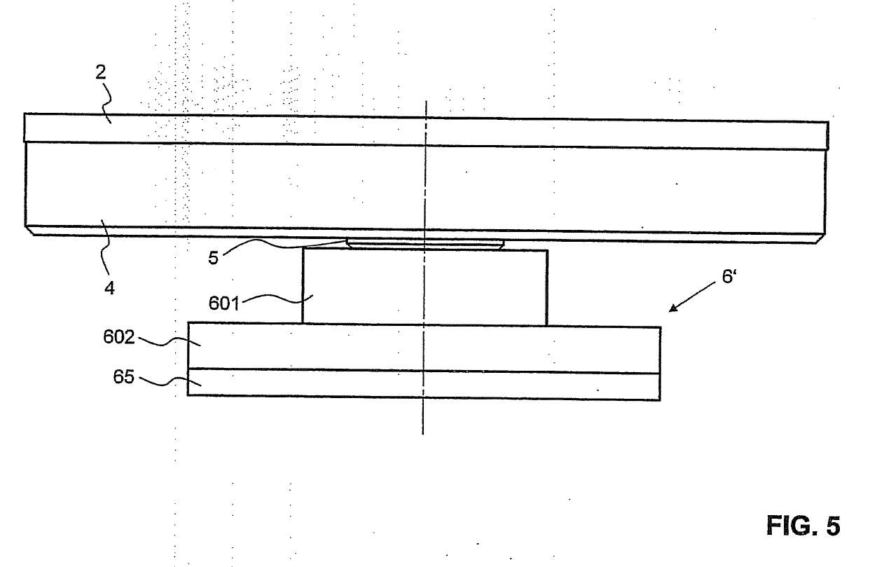

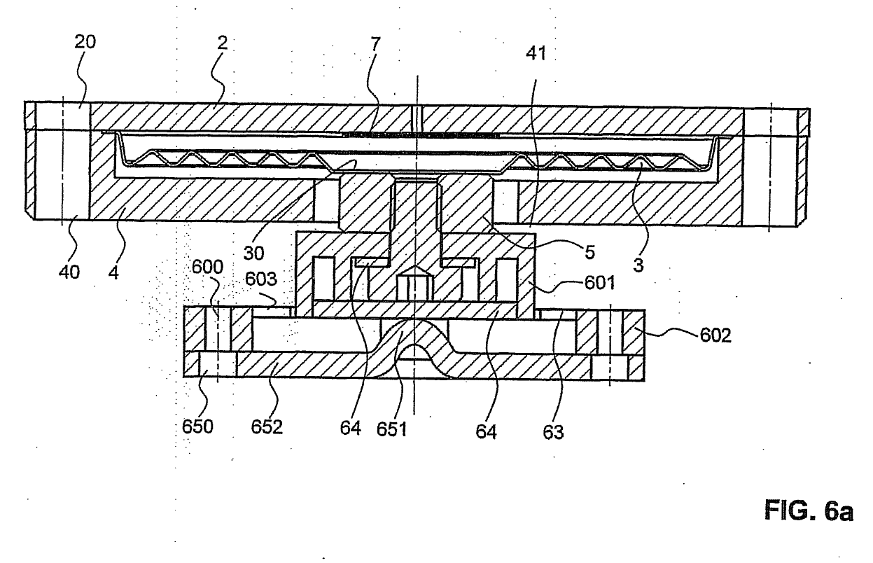

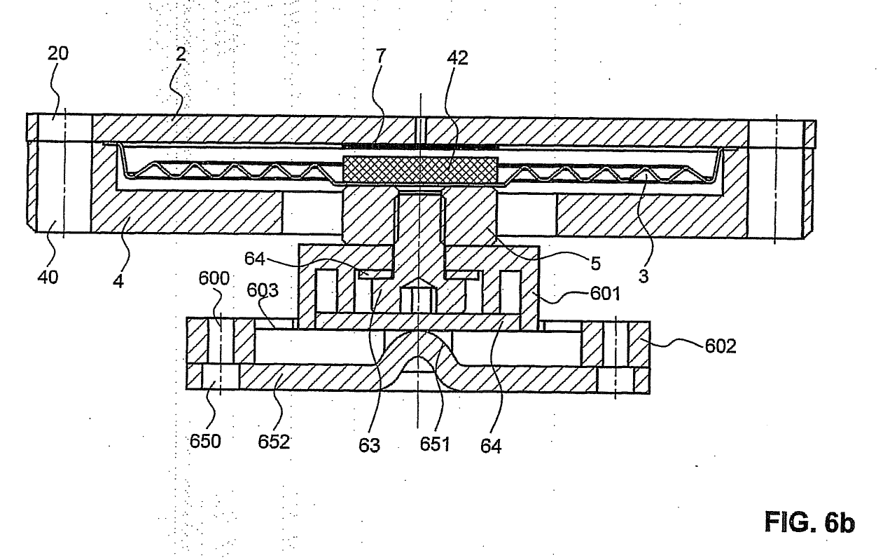

FIGS. 5 and 6a show a further embodiment of the inventive scale apparatus. Identical parts are denoted by the same reference symbols as in the other examples. Not illustrated in the figure is the upper housing part, but the latter is preferably also arranged here above the printed circuit board 2, and is connected to the lower housing part 4. As in the above example, all the parts in this example are also of rotationally symmetrical design, the axes of rotation of the parts forming a common axis in the assembled state of the scale apparatus.

The design with regard to the sensor plate 3 and flat coil 7 as well as to their arrangement in the housing, and also the stop surface 41 are the same as in the above-described example in accordance with FIGS. 1 to 3. The essential difference is, now, that instead of use being made of the downwardly projecting pushbutton with rounded head and punctiform support on an underlayer a differently designed pushbutton 6′ is now being used.

Here, as well, the pushbutton 6′ has a punctiform support. However, it is arranged integrally in the pushbutton 6′. As is to be seen in FIG. 6a, the sensor plate 3 presses once again onto a sleeve 61 arranged under it. This sleeve 61 is preferably arranged in the middle and below the sensor plate 3 in a fashion spaced apart from the lower housing part 4. The sensor plate 3 preferably rests loosely on the sleeve 5 without the sleeve being connected in another way to the housing 1, 4 or the sensor plate 3. It can, however, also be screwed to the sensor plate 3, be welded onto the latter or be bonded thereto.

A multipartite pushbutton 6′ is arranged below the sleeve 5, that is to say on its end face remote from the sensor plate. With the aid of a screw 63 it is screwed into the sleeve 5 with a flat or rounded screw head and, preferably, a shim 64 arranged on the sleeve side. For this purpose, the sleeve 5 has a feed-through opening with an internal thread, the opening preferably running in the middle with reference to the sleeve 5 and/or preferably running in the middle with reference to the sensor plate 3.

The pushbutton 6′ has a balancing body 60 designed in a sprung fashion and such that it shape can be varied, and a support plate 65 arranged hereunder. The support plate 65 can be permanently screwed to the balancing body 60. To this end, the balancing body 60 has threaded bores 600, and the support plate 65 has bores 650 fitting therewith.

The balancing body 60 bears with an upper flat end face on a lower flat end face of the sleeve 5. In addition, it has a feed-through opening that is passed through by the screw 63.

Furthermore, the balancing body 60 has a cage 601 that merges on its lower side into a connecting flange 602. Connection to the flange 602 is by way of spring members 603.

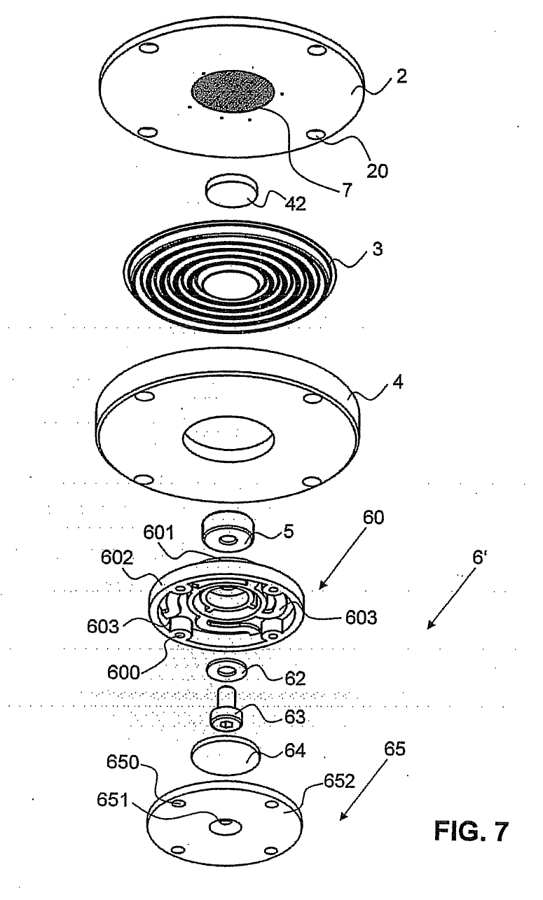

As is to be seen in FIG. 7, with reference to its central axis the balancing body 60 is designed in a rotationally symmetrical fashion. It is preferably produced in one piece from a plastic. In this case, at least the spring members 603 are of flexible, in particular elastic, design. In one exemplary embodiment, the cage 601 and the flange 602 are of rigid design. In another embodiment, they are also of flexible, in particular elastic, design. The balancing body 60 can also be made from metal or another suitable material.

The cage 601 has a lower receiving opening with an upper stop, in which an intermediate plate 64 is held. It is preferably rigidly connected to the cage 601 or held in it positively. The intermediate plate 64 has a flat surface, at least on its underside averted from the screw. It is preferably of plane-parallel design. The intermediate plate 64 is made from a dimensionally stable and rigid material, in particular from plastic, ceramic or metal.

The support plate 65 likewise has a lower flat surface 652. The latter serves as a foot, and thus as a supporting surface of the entire device. However, it can also be fastened on a further device foot (not illustrated here).

The support plate 65 has an elevation 651 that is directed upward toward the sensor plate 3 and is preferably designed in the shape of a hemisphere or spherical cap. The elevation 651 permits punctiform support. The punctiform support is preferably located in the middle with respect to the sensor plate 3 and/or on the central axis of the intermediate plate 64 and thus of the cage 601 or of the balancing body 60.

The intermediate plate 64 now rests loosely on this elevation 651. It is thereby possible to compensate nonuniform loads.

Particularly in the application in accordance with FIG. 4, this embodiment has the advantage that although four feet with pushbuttons are present, and thus there is support at four points, the feet cannot wobble because each foot itself has an appropriate compensation. The lower supporting surface 652 of the lower support plate 65 can therefore be of flat design, and this facilitates the designing of the scale apparatus. These lower support plates 65 can therefore be used simultaneously as standing feet of the scale apparatus with the aid of which the scale apparatus can be placed on a bathroom floor or a table or the like.

Instead of using the stop 41, it is also possible, for example, to use a stop that is arranged on a base plate (not illustrated here) on which the support plate 65 is also mounted. In this case, the stop projects upward from the base plate and ends at a spacing from the lower end face of the lower housing part 4.

FIGS. 6b and 7 illustrate a preferred variant of a stop. Here, it is arranged between the diaphragm or sensor plate 3 and printed circuit board 2. The stop 42, preferably a flat cylindrical body made from plastic, or another electrically nonconductive material preferably rests in the middle on the sensor plate 3 and ends above at a spacing from the coil 7. The spacing defines the maximum path by which the sensor element can be actuated. It is also possible to arrange the spacing 42 on the outer circumference of the sensor plate 3 instead of in the middle in the form of a closed ring.

The inventive balance or scales is of simple design, can be produced cost-effectively and can nevertheless be used in a versatile fashion.

### LIST OF REFERENCE SYMBOLS

1 Upper housing part

10 First feed-through opening

11 Cable opening

12 Supporting surface

2 Printed circuit board

20 Second feed-through opening

21 Opening

3 Sensor plate

30 Pressure surface

4 Lower housing part

40 Blind hole

41 Stop surface

42 Stop

5 Sleeve

6 Pushbutton

6′ Pushbutton

60 Balancing body

600 Threaded bore

601 Cage

602 Connecting flange

603 Spring member

62 Shim

63 Screw

64 Intermediate plate

65 Support plate

650 Bore

651 Elevation

652 Supporting surface

7 Flat coil

8 First cavity

9 Second cavity

W Weighing element

P Support plate

E Evaluation electronics

1. A scale apparatus having a supporting surface for supporting a weight to be weighed, having an electrically conducting sensor plate, having a flat coil, arranged at a spacing from the sensor plate, for the inductive measurement of a spacing between the sensor plate and the flat coil, having a housing surrounding the sensor plate and the flat coil, and having a pushbutton that projects from the housing and that is connected to the sensor plate.

2. The scale apparatus as claimed in claim 1, wherein the pushbutton projects downward beyond the housing on an underside of the housing, and the supporting surface is arranged on the opposite side of the housing.

3. The scale apparatus as claimed in claim 1, wherein the scale apparatus has a stop for the purpose of avoiding overloading.

4. The scale apparatus as claimed in claims 2 or 3, wherein the underside of the housing forms a lower stop surface of the scale apparatus.

5. The scale apparatus as claimed in claim 3, wherein a distance element is arranged between the sensor plate and flat coil.

6. The scale apparatus as claimed in claim 1, wherein the flat coil is arranged above the sensor plate.

7. The scale apparatus as claimed in claim 1, wherein the pushbutton is arranged on a flat surface of the sensor plate.

8. The scale apparatus as claimed in claim 1, wherein the sensor plate is a diaphragm.

9. The scale apparatus as claimed in claim 8, wherein the diaphragm is round.

10. The scale apparatus as claimed in claim 9, wherein the diaphragm has concentric annular corrugations.

11. The scale apparatus as claimed in claim 1, wherein the sensor plate is a torsion bar.

12. The scale apparatus as claimed in claim 1, wherein the sensor plate is made from metal.

13. The scale apparatus as claimed in claim 1, wherein the housing is made at least partly from metal.

14. The scale apparatus as claimed in claim 1, wherein the flat coil is arranged on a printed circuit board, and wherein the printed circuit board is held between an upper part and a lower part of the housing.

15. The scale apparatus as claimed in claim 1, wherein the pushbutton has a punctiform supporting surface.

16. The scale apparatus as claimed in claim 15, wherein the punctiform supporting surface is arranged inside the pushbutton, and the pushbutton has a lower flat supporting surface.

17. The scale apparatus as claimed in claim 16, wherein the pushbutton has a balancing body with spring members.

18. The scale apparatus as claimed in claim 1, wherein the housing is designed substantially in the shape of a flat cylinder with a round outline.

19. The scale apparatus as claimed in claim 1, wherein at least one opening is present so that ambient pressure bears on both sides of the sensor plate.

20. The scale apparatus as claimed in claim 1, wherein the housing has an airtight seal so that a constant pressure prevails in the interior of the housing.

21. The scale apparatus as claimed in claim 1, wherein the scale apparatus has a plurality of such housings each having a flat coil, a sensor plate and a pushbutton, the housings being interconnected via a common support plate for supporting the weight to be weighed.
